(19) United States
(12) Patent Application Publication
(10) Pub. No.: US 2016/0365045 A1
(43) Pub. Date: Dec. 15, 2016

(54) METHOD FOR DRIVING LIQUID CRYSTAL DISPLAY PANEL

(71) Applicant: SHENZHEN CHINA STAR OPTOELECTRONICS TECHNOLOGY CO., LTD, Shenzhen (CN)

(72) Inventors: Caiqin CHEN, Shenzhen (CN); Je Hao HSU, Shenzhen (CN)

(73) Assignee: Shenzhen China Star Optoelectronics, Shenzhen Guangdong (CN)

(21) Appl. No.: 14/416,645

(22) PCT Filed: Dec. 16, 2014
(86) PCT No.: PCT/CN2014/093902

§ 371 Date: Apr. 20, 2016

(30) Foreign Application Priority Data
Nov. 14, 2014 (CN) 201410649987.X

(51) Int. Cl. G09G 3/36; G02F 1/1362; G02F 1/1343

(52) U.S. Cl. CPC G09G 3/3614; G02F 1/134336; G02F 1/136286; G09G 3/3677; G09G 3/3688; G09G 2300/0452; G02F 2201/123; G02F 2001/134345; G09G 2310/0251; G09G 2320/0233; G09G 2310/06; G09G 2330/021

(57) ABSTRACT

A method for driving a liquid crystal display panel is disclosed. The method comprises the following steps: providing, during a first time period after a polarity of a voltage of a driving signal of a data line is reversed, a first scanning signal to turn on a first scanning line, so as to charge a first sub pixel connected with the first scanning line through said data line; providing a second scanning signal to turn on at least one second scanning line, so as to charge a second sub pixel connected with the second scanning line through said data line, wherein a turn-on voltage of the first scanning signal is higher than a turn-on voltage of the second scanning signal, and a chamfering voltage of the first scanning signal is the same as a chamfering voltage of the second scanning signal.

### CROSS REFERENCE TO RELATED APPLICATION

The present application claims benefit of Chinese patent application CN 201410649987.X, entitled “Method for Driving Liquid Crystal Display Panel” and filed on Nov. 14, 2014, which is incorporated herein by reference.

### FIELD OF THE INVENTION

The present disclosure relates to the technical field of display, and particularly to a method for driving liquid crystal display panel.

### BACKGROUND OF THE INVENTION

With the development of liquid crystal display technology, most of the liquid crystal displays of various kinds available nowadays have the advantages of low cost, low power consumption, and high performance. The various kinds of components of the liquid crystal display panel can be integrated through precise design, so that a best display effect can be ensured while the cost and power consumption thereof can be reduced.

In the field of Thin Film Transistor Liquid Crystal Display (TFT-LCD), the liquid crystal display panel needs to be provided with a large amount of source driving circuits and gate driving circuits to perform pixel driving in vertical direction and horizontal direction respectively. Compared with source driving chips, the cost and power consumption of gate driving chips are relatively low. Therefore, the number of data lines can be reduced through a reasonable design of the structure of the pixel array, so that the number of source driving chips used therein can be reduced, and the manufacturing cost and power consumption of the liquid crystal display can be both reduced accordingly.

For example, in the prior art, the sub pixels adjacent to each other along a horizontal direction of Half Source Driving (HSD) pixel array share the same data line, so that the number of data lines is half of the number of data lines of traditional liquid crystal driving pixel array. The adjacent sub pixels in the same row are connected with different scanning lines, while sub pixels spaced from each other by one sub pixel in the same row are connected with the same scanning line. Therefore, the number of scanning lines is twice as the number of scanning lines of traditional liquid crystal driving pixel array.

In general, in a HSD pixel array, a two-horizontal line reversion driving mode, i.e., a two-row reversion driving mode can be used. The polarity of the voltage of the data driving signal is reversed once during two scanning cycles. Since the number of scanning lines is doubled, the scanning time allocated to each scanning line reduces, and thus the charge time of the sub pixel reduces accordingly. In addition, due to the impedance of data lines, a delay distortion of waveform of the voltage signal would be generated during the transmission of the voltage signal. Such distortion would become more serious near the ends of data lines. Consequently, a difference between a charge rate of sub pixels in odd-numbered columns and that of sub pixels in even-numbered columns at the ends of data lines would be generated. For example, sub pixels in odd-numbered columns driven at first are undercharged, and their brightness is relatively low. In contrast, sub pixels in even-numbered columns driven later are charged better, and their brightness is relatively high.

In this case, the sub pixels of the liquid crystal display panel would present different degrees of brightness in space during the same frame cycle, and bright-dark lines would occur in the LCD with a HSD pixel array.

### SUMMARY OF THE INVENTION

The technical problem to be solved by the present disclosure is to eliminate the defects of uneven brightness in space presented by a liquid crystal display panel.

In order to solve the aforesaid technical problem, the embodiments of the present disclosure provide a method for driving liquid crystal display panel, comprising the steps of:

providing, during a first time period after a polarity of a voltage of a driving signal of a data line is reversed, a first scanning signal to turn on a first scanning line, so as to charge a first sub pixel connected with the first scanning line through said data line;

providing, during at least one second time period after the first time period, a second scanning signal to turn on at least one second scanning line, so as to charge a second sub pixel connected with the second scanning line through said data line;

wherein a turn-on voltage of the first scanning signal is higher than a turn-on voltage of the second scanning signal, so as to compensate a difference between a charge rate of the first sub pixel charged by the data line and that of the second sub pixel charged by the data line; and
wherein a chamfering voltage of the first scanning signal is the same as a chamfering voltage of the second scanning signal, so that a sustaining voltage of the first sub pixel is the same as a sustaining voltage of the second sub pixel.

Preferably, said data line is used for driving said first sub pixel and said at least one second sub pixel, and the polarity of the voltage of the driving signal of said data line is reversed periodically.

Preferably, one second scanning line is provided, and a reversing cycle of the polarity of the voltage of the driving signal of said data line is equal to two scanning cycles.

Preferably, two second scanning lines are provided, and a reversing cycle of the polarity of the voltage of the driving signal of said data line is equal to three scanning cycles.

Preferably, the chamfering voltage of the second scanning signal is equal to the turn-on voltage thereof.

Preferably, the first time period after the polarity of the voltage of the driving signal of said data line is reversed is equal to the second time period in duration, and a turn-on time of said first scanning line is equal to a turn-on time of said at least one second scanning line in duration.

Preferably, the polarity of the voltage of the driving signal of said data line in the first time period is the same as that in the second time period.

Preferably, a polarity reversing mode of the voltage of the driving signal of said data line is row reversion.

Preferably, a feedthrough voltage of said first sub pixel is the same as a feedthrough voltage of said at least one second sub pixel.

Preferably, a pixel array of said liquid crystal display panel is a half source driving pixel array or a tri-gate pixel array.

According to the present disclosure, the sub pixels with a lower charge rate are provided with a higher turn-on voltage, so as to compensate a difference among charge rates of different sub pixels charged by the data line. In addition, the sub pixels are provided with the same chamfering voltage, so that the same feed-through voltage of the sub pixels can be guaranteed. In this case, the sub pixels, after being charged by the data line, can obtain the sustaining voltage with the same value through the effect of the feed-through voltage. The sub pixels can present a uniform degree of brightness in space, and thus the bright-dark lines in the liquid crystal display panel can be eliminated.

Other features and advantages of the present disclosure will be further explained in the following description, and partially become self-evident therefrom, or be understood through the embodiments of the present disclosure. The objectives and advantages of the present disclosure will be achieved through the structure specifically pointed out in the description, claims, and the accompanying drawings.

### BRIEF DESCRIPTION OF THE DRAWINGS

The accompanying drawings provide further understandings of the technical solution of the present disclosure or the prior art, and constitute one part of the description, but not for limiting the technical solution of the present disclosure.

FIG. 1 is a structural diagram of a HSD liquid crystal display panel according to Embodiment 1 of the present disclosure;

FIG. 2 schematically shows a waveform of a voltage of a driving signal of a data line and a scanning line according to a method for driving a HSD panel in the prior art;

FIG. 3 schematically shows a waveform of a voltage of a pixel electrode of a sub pixel of a HSD panel in the prior art;

FIG. 4 schematically shows a waveform of a voltage of a pixel electrode of a sub pixel according to a driving method of Embodiment 1 of the present disclosure;

FIG. 5 is a structural diagram of a tri-gate liquid crystal display panel according to Embodiment 2 of the present disclosure;

FIG. 6 schematically shows a waveform of a voltage of a driving signal of data line and scanning lines according to a method for driving a tri-gate panel in the prior art;

FIG. 7 schematically shows a waveform of a voltage of a pixel electrode of sub pixels of a tri-gate panel in the prior art; and

FIG. 8 schematically shows a waveform of a voltage of a pixel electrode of a sub pixel according to a driving method of Embodiment 2 of the present disclosure.

### DETAILED DESCRIPTION OF THE EMBODIMENTS

The present disclosure will be illustrated in more detail hereinafter with reference to the drawings to further clarify the objectives, technical solutions and advantages of the present disclosure. As long as there is no structural conflict, all the technical features mentioned in all the embodiments may be combined together in any manner, and the technical solutions obtained in this manner all fall within the scope of the present disclosure.

### Embodiment 1

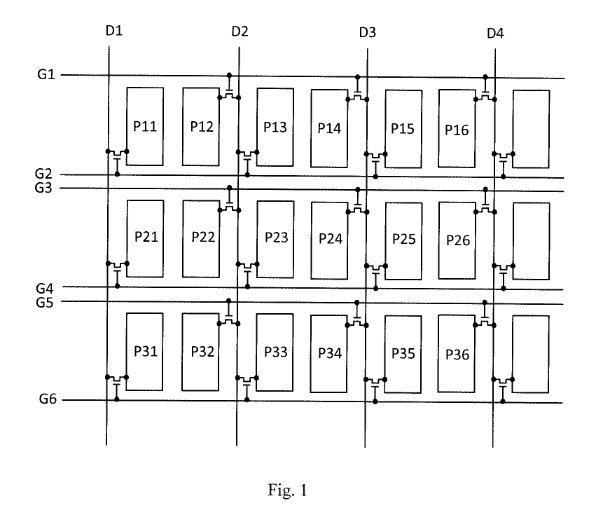

FIG. 1 is a structural diagram of a HSD liquid crystal display panel according to the present embodiment. As shown in FIG. 1, the display panel comprises a pixel array formed by a plurality of data lines (such as data lines D1, D2, D3, and D4 as shown in FIG. 1) and a plurality of scanning lines (such as scanning lines G1, G2, G3, and G4 as shown in FIG. 1) that are configured orthogonally to each other, and a plurality of sub pixels P11 to P36 that are configured in the array. For the sake of conciseness, it is defined here that a sub pixel Pxy is arranged in row x, and column y. For example, the sub pixel P12 is arranged in row 1, and column 2, and other sub pixels are arranged in the same manner.

The sub pixel P12 is connected with the scanning line G1 and the data line D2, and a sub pixel P13 is connected with the scanning line G2 and the data line D2. P12 and P13 are arranged at the two sides of the data line D2 respectively. Similarly, a sub pixel P22 is connected with the scanning line G3 and the data line D2, and a sub pixel P23 is connected with the scanning line G4 and the data line D2. P22 and P23 are arranged at the two sides of the data line D2 respectively. Other sub pixels are arranged in a similar manner.

In the prior art, the sub pixels of a HSD liquid crystal display panel would present different degrees of brightness in space during the same frame cycle, and thus bright-dark lines along the vertical direction would occur in the LCD with a HSD pixel array. There are mainly two reasons for this phenomenon.

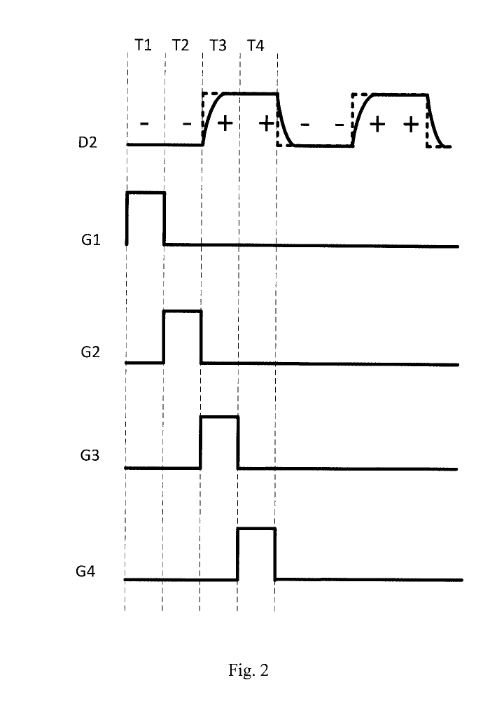

First, the RC delay of the data line would lead to differences among charge rates of the sub pixels. The waveform of a voltage of a driving signal of a data line and a scanning line during one frame cycle is shown in FIG. 2. According to the present embodiment, the polarity of the voltage of the driving signal provided by the data line D2 is reversed periodically. A first time period after polarity reversion is a scanning cycle T3, and a second time period is a scanning cycle T4. The data line D2 is used for driving the first sub pixel P22 and the second sub pixel P23. During the scanning cycle T3, the first scanning line G3 is turned on, and the data line D2 charges the first sub pixel P22 with a data signal voltage of a positive polarity. Similarly, during the scanning cycle T4, the second scanning line G4 is turned on, and the data line D2 charges the second sub pixel P23 with a data signal voltage of a positive polarity. As shown by the dotted line in FIG. 2, due to the RC delay of the data line D2, during a certain time period from the beginning of the scanning cycle T3, the driving signal of the data line D2 cannot reach a preset charge level, which renders that the first sub pixel P22 is undercharged, and the brightness thereof is relatively low. By contrast, during the scanning cycle T4, the driving signal of the data line D2 has stably reached the preset charge level, so that the second sub pixel P23 can be charged completely, and the brightness thereof is relatively high.

Second, the reversion driving mode would lead to differences among charge rates of the sub pixels. In general, in a HSD pixel array, a two-horizontal line reversion driving mode, i.e., a two-row reversion driving mode can be used. During two scanning cycles, the polarity of the voltage of the data driving signal is reversed once. That is to say, a reversing cycle of the polarity of the voltage of the driving signal of the data line is equal to two scanning cycles. As shown in FIG. 2, at an initial moment of the scanning cycle T3, the polarity of the voltage of the driving signal of the data line D2 is reversed, and a low-level signal in the scanning cycle T2 jumps to a high-level signal in the scanning cycle T3. At this time, since the voltage of the driving signal of the data line D2 should be changed to a rather large extent, the driving signal of the data line D2 cannot reach the preset charge level during a certain time period from the beginning of the scanning cycle T3, which renders that the sub pixel P22 is undercharged. By contrast, at an initial moment of the scanning cycle T4, the polarity of the voltage of the driving signal of the data line D2 is not reversed. During the scanning cycle T4, the driving signal of the data line D2 can be maintained in the stable preset charge level, and thus the sub pixel P23 can be charged completely.

On the other hand, since there are parasite capacitors among the sub pixels, a feedthrough voltage would be generated in a pixel electrode of a sub pixel at the moment when the scanning line is turned off, and thus the voltage of the pixel electrode would be reduced. The feedthrough voltage ΔVp can be expressed as:

ΔVp=(Vgh−Vgl)×Cgs/(Cst+Clc+Cgs),

wherein Vgh is a high-level signal of a driving voltage of the scanning line, i.e., a turn-on voltage; Vgl is a low-level signal of the driving voltage of the scanning line, i.e., a turn-off voltage; Cgs is the parasite capacitor; Cst is a storage capacitor; and Clc is a liquid crystal capacitor.

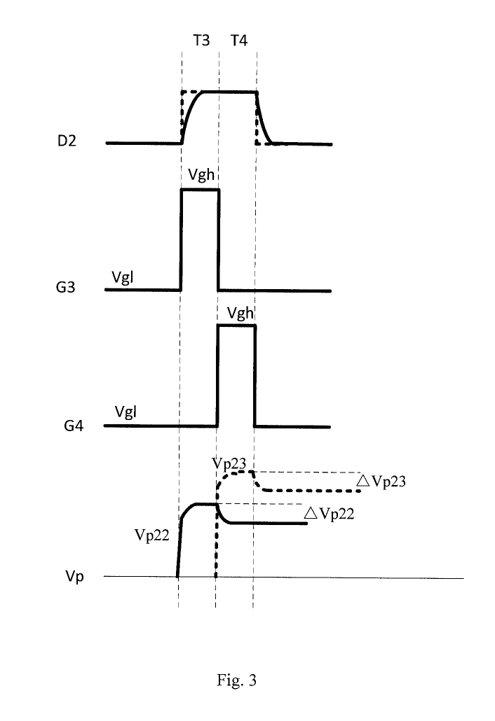

According to the method for driving a HSD panel in the prior art, the values of the voltages of the driving signals provided by different scanning lines are the same with each other. That is to say, the turn-on voltages of all sub pixels are the same with each other, and the turn-off voltages of all sub pixels are the same with each other. Take the first sub pixel P22 and the second sub pixel P23 as an example, the waveforms of the voltages of the pixel electrodes thereof are shown in FIG. 3.

At the initial moment of the scanning cycle T3, the scanning line G3 is turned on, and the driving signal of the data line D2 cannot reach the preset charge level, which would renders that the charge rate of the sub pixel P22 charged by the data line D2 is relatively low. At a moment when the scanning cycle T3 comes to an end, a pixel voltage Vp22 of the sub pixel P22 reaches its highest value. After the scanning line G3 is turned off, a feedthrough voltage Vp22 gradually reduces the pixel voltage Vp22 to a stable sustaining voltage.

At the initial moment of the scanning cycle T4, the scanning line G4 is turned on, and the driving signal of the data line D2 can be maintained in the stable preset charge level, so that the charge rate of the sub pixel P23 charged by the data line D2 is relatively high. At a moment when the scanning cycle T4 comes to an end, a pixel voltage Vp23 of the sub pixel P23 reaches its highest value, which is higher than the highest value of the pixel voltage Vp22 of the sub pixel P22. After the scanning line G4 is turned off, a feedthrough voltage ΔVp23 gradually reduces the pixel voltage Vp23 to a stable sustaining voltage. Since the voltage of the driving signal of the scanning line G3 is completely the same as that of the scanning line G4, i.e., the feedthrough voltage ΔVp23 is equal to the feedthrough voltage ΔVp22, the sustaining voltage of the sub pixel P22 obtained therein is lower than that of the sub pixel P23, which would result in the brightness presented by the sub pixel P22 being lower than that of the sub pixel P23.

Based on the above analysis, the present embodiment further provides a method for driving a HSD liquid crystal display panel. According to the aforesaid method, the sub pixels with a lower charge rate are provided with a higher turn-on voltage, so as to compensate a difference among charge rates of different sub pixels charged by the data line. In addition, the sub pixels are provided with the same chamfering voltage, so that the same feed-through voltage of the sub pixels can be guaranteed. In this case, the sub pixels, after being charged by the data line, can obtain the sustaining voltage with the same value through the effect of the feed-through voltage. The sub pixels can present a uniform degree of brightness in space, and thus the bright-dark lines along the vertical direction of the HSD liquid crystal display panel can be eliminated.

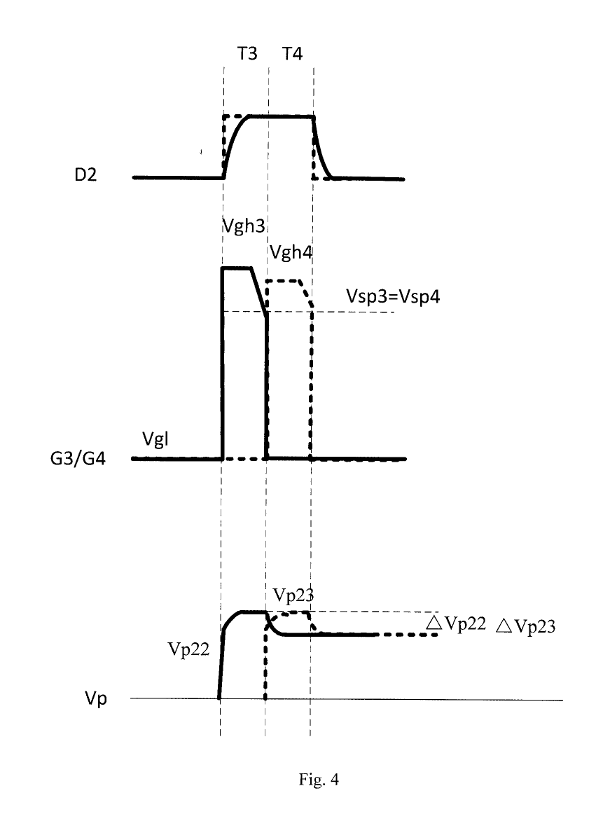

The driving method of the present embodiment will be illustrated in detail below with reference to FIG. 4.

At an initial moment of a scanning cycle T3, the first scanning line G3 is turned on, and a driving signal of the data line D2 cannot reach a preset charge level. In order to compensate the relatively low charge rate of the sub pixel P22 charged by the data line D2, during a certain time period from the beginning of the scanning cycle T3, a first scanning driving signal, which is provided by the first scanning line G3, has a relatively high turn-on voltage Vgh3. In addition, at an end of the scanning cycle T3, the driving signal of G3 has a chamfering voltage Vsp3, so as to reduce the turn-on voltage. At the end of the scanning cycle T3, a pixel voltage Vp22 of the sub pixel P22 reaches its highest value. After the scanning line G3 is turned off, a feedthrough voltage ΔVp22 gradually reduces the pixel voltage Vp22 to a stable sustaining voltage.

As shown in FIG. 4, a polarity of the driving signal of the data line D2 in the scanning cycle T3 is the same as that in a scanning cycle T4. At an initial moment of the scanning cycle T4, the second scanning line G4 is turned on, and the driving signal of the data line D2 can be maintained in the stable preset charge level. During a certain time period from the beginning of the scanning cycle T4, a turn-on voltage Vgh4 of a second scanning driving signal, which is provided by the second scanning line G4, is lower than Vgh3, so as to enable the data line D2 to provide the same charge rate to the sub pixel P22 and the sub pixel P23. In addition, at an end of the scanning cycle T4, the driving signal of G4 has a chamfering voltage Vsp4. In this case, at the end of the scanning cycle T4, a pixel voltage Vp23 of the sub pixel P23 reaches its highest value, which is equal to the highest value of Vp22. After the scanning line G4 is turned off, a feedthrough voltage ΔVp23 gradually reduces the pixel voltage Vp23 to a stable sustaining voltage.

Further, the chamfering voltage Vsp3 can be configured as being equal to the chamfering voltage Vsp4, so that the feedthrough voltage ΔVp23 can be equal to the feedthrough voltage ΔVp22. In this case, the sustaining voltage Vp22 of the sub pixel P22 obtained therein is equal to the sustaining voltage Vp23 of the sub pixel P23, so that the brightness presented by the sub pixel P22 is equal to that of the sub pixel P23.

It should be noted that, the first time period T3 is equal to the second time period T4 in duration. That is, the time period during which the scanning line G3 is turned on is equal to the time period during which the scanning line G4 is turned on. According to the driving method of the present embodiment, only the voltage of the scanning square wave pulse provided by a conventional gate driving chip needs to be changed, while the gate driving chip itself need not to be changed. Therefore, the driving method of the present embodiment is compatible with the driving chips in the prior art.

Furthermore, in order to simplify the configuration thereof, the turn-on voltage of the second scanning driving signal provided by the second scanning line G4 can be arranged to be equal to the chamfering voltage thereof, i.e., Vgh4=Vsp4=Vsp3. In this case, the scanning driving signal provided by G4 is a standard square wave pulse. Under the condition that the turn-on voltage Vgh4 is lower than Vgh3, the difference between the charge rate of the sub pixel P22 and that of the sub pixel P23 charged by the data line D2 can be compensated as well, so that the peak value of Vp22 is equal to that of Vp23. In addition, the Vgh4 can be arranged to be equal to Vsp3, so that it can be ensured that the feedthrough voltage ΔVp22 is equal to the feedthrough voltage ΔVp23, and the sustaining voltage of P22 is equal to that of P23.

It should be noted that, the value of the turn-on voltage Vgh of the scanning signal can be configured based on the aforesaid two reasons for the display defect of bright-dark lines. That is, the sub pixel P22, which is poorly charged, can be provided with a relatively high turn-on voltage, so that the difference among charge rates of sub pixels resulted from the RC delay of the data line D2 can be compensated, and the difference among charge rates of sub pixels resulted from the two-horizontal line reversion driving mode can be compensated as well.

Moreover, the scanning signals can be configured with the same turn-off voltage Vgl and chamfering voltage Vsp, so that the voltage differences (Vsp−Vgl) of the two scanning lines, which result in the feedthrough voltages thereof, are equal to each other at the moment when the scanning lines G3 and G4 are turned off. In this case, it can be ensured that the feedthrough voltage ΔVp22 is equal to the feedthrough voltage ΔVp23.

It can be readily understood by a person skilled in the art that, the two-row reversion driving mode is applicable for the HSD liquid crystal display panels and traditional liquid crystal display panels. The scanning signal of odd-numbered scanning lines and the scanning signal of even-numbered scanning lines can be configured with different turn-on voltages, so that the difference among charge rates of sub pixels charged by the data lines can be compensated. Meanwhile, the scanning signals of all scanning lines are provided with the same turn-off voltage, so that the final charge voltage of the sub pixels in odd columns is consistent with that of the sub pixels in even columns, and the bright-dark lines along vertical direction can be eliminated.

### Embodiment 2

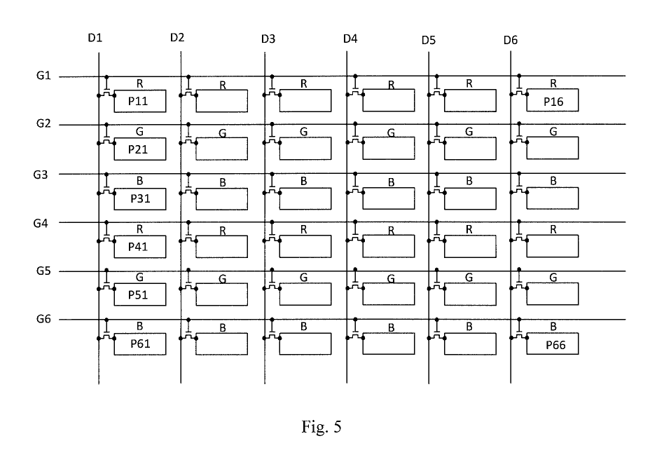

FIG. 5 is a structural diagram of a tri-gate liquid crystal display panel according to the present embodiment. As shown in FIG. 5, the display panel comprises a pixel array formed by a plurality of data lines (such as data lines D1 to D6 as shown in FIG. 5) and a plurality of scanning lines (such as scanning lines G1 to G6 as shown in FIG. 5) that are configured orthogonally to each other, and a plurality of sub pixels P11 to P66 that are configured in the array, wherein a red sub pixel (R) P11, a green sub pixel (G) P21, and a blue sub pixel (B) P31 form a pixel unit.

In the case that a resolution of the display panel is n×m, a number of scanning lines of the tri-gate liquid crystal display panel is 3m, and a number of data lines thereof is n. By contrast, the number of scanning lines of a traditional display panel is m, and the number of data lines thereof is 3n. In other words, under the same resolution, the number of scanning lines of the tri-gate liquid crystal display panel is increased to three times as that of the traditional display panel, and the number of data lines thereof is reduced to one third of that of the traditional display panel. That is to say, in the tri-gate liquid crystal display panel, relatively more gate driving chips and relatively less source driving chips are used, and thus the manufacturing cost and power consumption thereof can be reduced.

In the prior art, the sub pixels of the tri-gate liquid crystal display panel would present different degrees of brightness in space during the same frame cycle, and thus bright-dark lines along the horizontal direction would occur in the tri-gate pixel array. The reasons for this display defect are stated below.

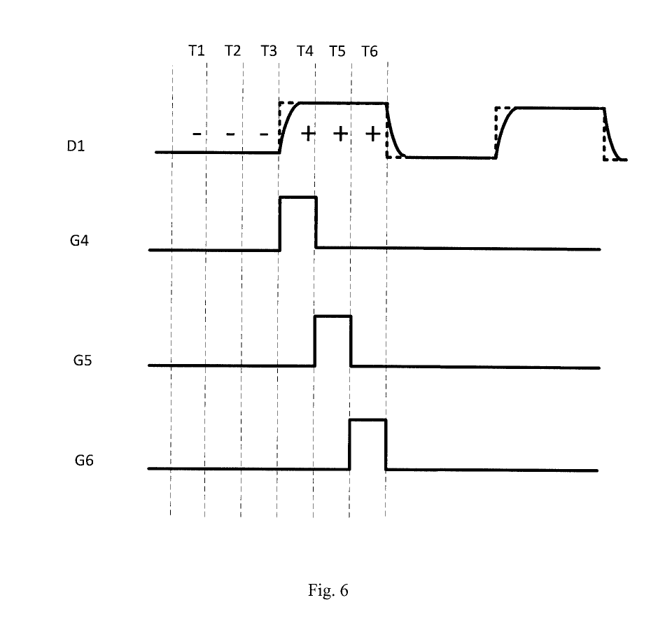

The waveform of a voltage of a driving signal of data line and scanning lines in one frame cycle is shown in FIG. 6. A polarity of a driving signal provided by a data line D1 is reversed periodically. According to the present embodiment, a first time period after polarity reversion is a scanning cycle T4, a second time period is a scanning cycle T5, and another second time period is a scanning cycle T6. In the present embodiment, the data line D1 is used for driving a first sub pixel P41, a second sub pixel P51, and another second sub pixel P61. During the scanning cycle T4, a first scanning line G4 is turned on, and the data line D1 charges the sub pixel P41 with a data signal voltage of a positive polarity. During the scanning cycle T5, a second scanning line G5 is turned on, and the data line D1 charges the sub pixel P51 with a data signal voltage of a positive polarity. Similarly, during the scanning cycle T6, another second scanning line G6 is turned on, and the data line D1 charges the sub pixel P61. The charge time of the sub pixels of the tri-gate display panel reduces two thirds compared with that of the traditional display panel, which would result in the problem of insufficient charge of the sub pixels.

As shown by the dotted line in FIG. 6, due to the RC delay of the data line D1, during a certain time period from the beginning of the scanning cycle T4, the driving signal of the data line D1 cannot reach a preset charge level, which renders that the sub pixel P41 is undercharged, and the brightness thereof is relatively low. By contrast, during the scanning cycles T5 and T6, the driving signal of the data line D1 has stably reached the preset charge level, so that the sub pixels P51 and P61 can be charged completely, and the brightness thereof is relatively high.

In addition, in the tri-gate pixel array, a three-horizontal line reversion driving mode, i.e., a three-row reversion driving mode can be used. During three scanning cycles, the polarity of the voltage of the data driving signal is reversed once. That is to say, a reversing cycle of the polarity of the voltage of the driving signal of the data line is equal to three scanning cycles. As shown in FIG. 6, at an initial moment of the scanning cycle T4, the polarity of the voltage of the driving signal of the data line D1 is reversed, and a low-level signal in the scanning cycle T3 jumps to a high-level signal in the scanning cycle T4. At this time, since the voltage of the driving signal of the data line D1 should be changed to a rather large extent, the driving signal of the data line D1 cannot reach the preset charge level during a certain time period from the beginning of the scanning cycle T4, which renders that the sub pixel P41 is undercharged. By contrast, at an initial moment of each of the scanning cycles T5 and T6, the polarity of the voltage of the driving signal of the data line D1 is not reversed. During the scanning cycles T5 and T6, the driving signal of the data line D1 can be maintained in the stable preset charge level, and thus the sub pixels P51 and P61 can be charged completely.

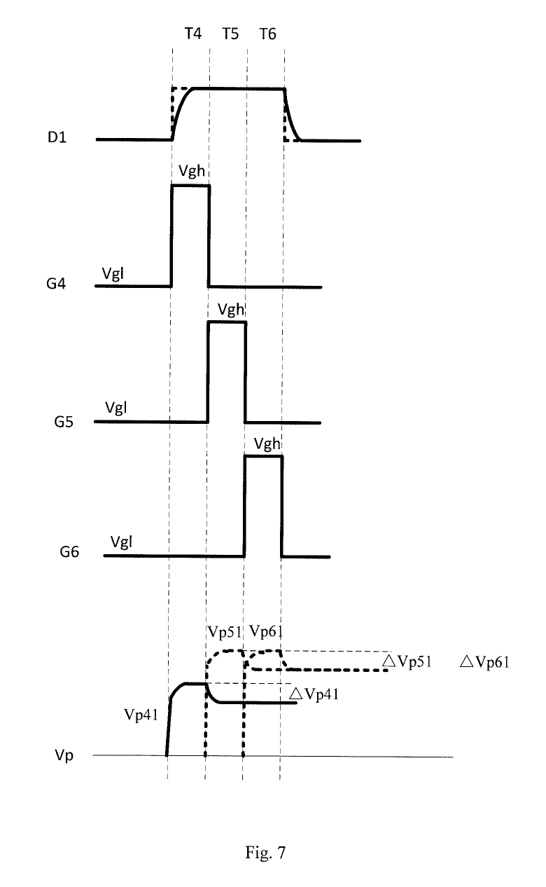

According to the method for driving a tri-gate panel in the prior art, the values of the voltages of the driving signals provided by different scanning lines are the same with each other. That is to say, the turn-on voltages of all sub pixels are the same with each other, and the turn-off voltages of all sub pixels are the same with each other. Affected by a feedthrough voltage resulted from the parasite capacitors thereof, the waveforms of the voltages of the pixel electrodes of the sub pixels P41, P51, and P61 are shown in FIG. 7.

At the initial moment of the scanning cycle T4, the scanning line G4 is turned on, and the driving signal of the data line D1 cannot reach the preset charge level, which would renders that the charge rate of the sub pixel P41 charged by the data line D1 is relatively low. At a moment when the scanning cycle T4 comes to an end, a pixel voltage Vp41 of the sub pixel P41 reaches its highest value. After the scanning line G4 is turned off, a feedthrough voltage ΔVp41 gradually reduces the pixel voltage Vp41 to a stable sustaining voltage.

At the initial moment of the scanning cycle T5, the scanning line G5 is turned on, and the driving signal of the data line D1 can be maintained in the stable preset charge level, so that the charge rate of the sub pixel P51 charged by the data line D1 is relatively high. At a moment when the scanning cycle T5 comes to an end, a pixel voltage Vp51 of the sub pixel P51 reaches its highest value, which is higher than the highest value of the pixel voltage Vp41 of the sub pixel P41. After the scanning line G5 is turned off, a feedthrough voltage ΔVp51 gradually reduces the pixel voltage Vp51 to a stable sustaining voltage.

Similarly, at the initial moment of the scanning cycle T6, the scanning line G6 is turned on, and the charge rate of the sub pixel P61 charged by the data line D1 is relatively high. After the scanning line G6 is turned off, a feedthrough voltage ΔVp61 gradually reduces the pixel voltage Vp61 to a stable sustaining voltage.

Since the voltage of the driving signal of the scanning line G4 is completely the same as those of the scanning lines G5 and G6, i.e., the feedthrough voltages ΔVp41, ΔVp51 and ΔVp61 are equal to one another, the stable pixel voltage Vp41 of the sub pixel P41 obtained in the same frame period is lower than those of the sub pixels P51 and P61, which would result in that the brightness presented by the sub pixel P41 is relatively low while the brightness presented by the sub pixels P51 and P61 is relatively high. On the whole, the bright-dark lines along the horizontal direction would occur in the tri-gate liquid crystal display panel.

Based on the above analysis, the present embodiment further provides a method for driving a tri-gate liquid crystal display panel. According to the aforesaid method, the sub pixels with a lower charge rate are provided with a higher turn-on voltage, so as to compensate a difference among charge rates of different sub pixels charged by the data line. In addition, the feed-through voltages of the sub pixels are the same with one another. In this case, the sub pixels, after being charged by the data line, can obtain the sustaining voltage with the same value through the effect of the feed-through voltage. The sub pixels can present a uniform degree of brightness in space, and thus the bright-dark lines of the tri-gate liquid crystal display panel can be eliminated.

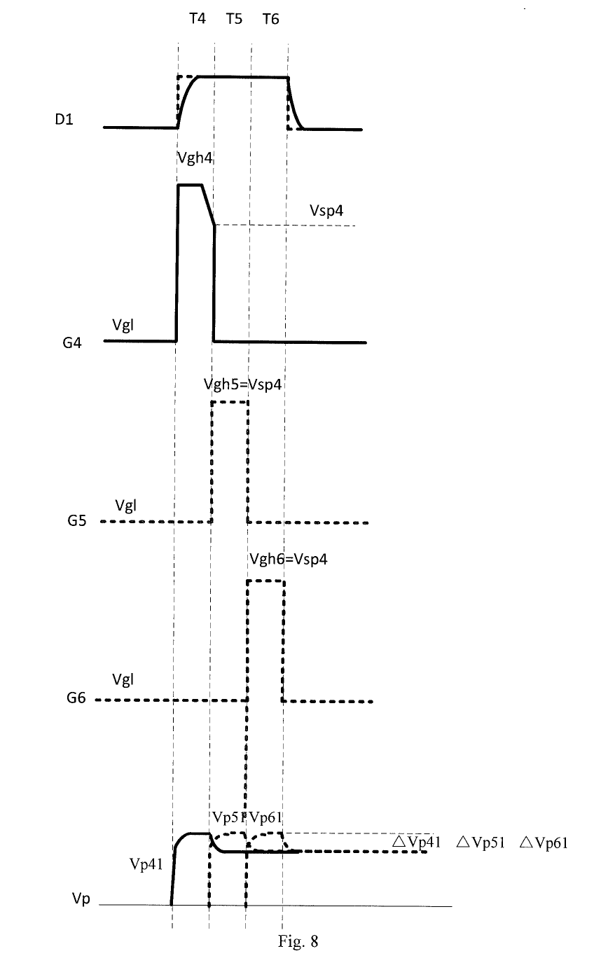

The driving method of the present embodiment will be illustrated in detail below with reference to FIG. 8.

At an initial moment of a scanning cycle T4, a driving signal of the data line D1 cannot reach a preset charge level. In order to compensate the relatively low charge rate of the sub pixel P41 charged by the data line D1, during a certain time period from the beginning of the scanning cycle T4, a first scanning driving signal, which is provided by the first scanning line G4, has a relatively high turn-on voltage Vgh4. In addition, at an end of the scanning cycle T4, the driving signal of G4 has a chamfering voltage Vsp4, so as to reduce the turn-on voltage. At the end of the scanning cycle T4, a pixel voltage Vp41 of the sub pixel P41 reaches its highest value. After the scanning line G4 is turned off, a feedthrough voltage ΔVp41 gradually reduces the pixel voltage Vp41 to a stable sustaining voltage.

As shown in FIG. 8, a polarity of the driving signal of the data line D1 in the scanning cycle T4 is the same as that in a scanning cycle T5. At an initial moment of the scanning cycle T5, the driving signal of the data line D1 can be maintained in the stable preset charge level. During the scanning cycle T5, a turn-on voltage Vgh5 of a second scanning driving signal, which is provided by the second scanning line G5, is lower than Vgh4, so as to enable the data line D1 to provide the same charge rate to the sub pixels P41 and P51. In addition, during the scanning cycle T5, the driving signal of G5 is a standard square wave pulse, and Vgh5 is equal to Vsp4. In this case, at the end of the scanning cycle T5, a pixel voltage Vp51 of the sub pixel P51 reaches its highest value, which is equal to the highest value of Vp41. After the scanning line G5 is turned off, a feedthrough voltage ΔVp51 gradually reduces the pixel voltage Vp51 to a stable sustaining voltage. The feedthrough voltage ΔVp51 is equal to the feedthrough voltage ΔVp41. In this case, the sustaining voltage of the sub pixel P41 obtained therein is equal to that of the sub pixel P51, so that the brightness presented by the sub pixel P41 is equal to that of the sub pixel P51.

Similarly, during the scanning cycle T6, the second scanning driving signal provided by another second scanning line G6 is a standard square wave pulse, wherein the turn-on voltage Vgh6 thereof is lower than Vgh4 and equal to Vsp4. In this case, the brightness presented by the sub pixels P41, P51, and P61 are the same with one another.

It should be noted that, the scanning cycles T4, T5, and T6 are equal to one another. That is, the time period during which the scanning line G4 is turned on is equal to the time period during which the scanning line G5 is turned on, and equal to the time period during which the scanning line G6 is turned on. Therefore, according to the driving method of the present embodiment, only the voltage of the scanning square wave pulse provided to the scanning line G4 by a gate driving chip needs to be changed, while the driving mode of a source driving chip need not to be changed. Hence, the driving method of the present embodiment is compatible with the driving chips in the prior art.

Moreover, the scanning signals provided by G5 and G6 can be configured with a chamfering voltage, the technical solution of which is similar to that of embodiment 1, and the details thereof are no longer repeated here.

It can be readily understood by a person skilled in the art that, as to the tri-gate liquid crystal display panel, the 3k scanning lines can be configured with a turn-on voltage different from those of the 3k+1 and 3k+2 scanning lines (k is an integer and equal to or larger than 0), so that the difference among charge rates of the sub pixels charged by the data line can be compensated. In addition, the scanning lines are provided with the same chamfering voltage, so that the charge voltages of the sub pixels in different rows are the same with one another, and the bright-dark lines along horizontal direction can be eliminated.

In addition, the three-row reversion driving mode is also applicable for the HSD liquid crystal display panels of embodiment 1 and traditional liquid crystal display panels. Under the reversion driving mode, the 3k scanning lines can be configured with a turn-on voltage different from those of the 3k+1 and 3k+2 scanning lines, so that the difference among charge rates of the sub pixels charged by the data line can be compensated, and the display defect of uneven brightness can be eliminated.

The above embodiments are described only for better understanding, rather than restricting, the present disclosure. The two-horizontal line reversion driving mode and three-horizontal line reversion driving mode provided in the embodiments are not used for restricting the present disclosure, and other reversion driving modes are applicable for the present disclosure. Any person skilled in the art can make amendments to the implementing forms or details without departing from the spirit and scope of the present disclosure. The protection scope of the present disclosure shall be determined by the scope as defined in the claims.

1. A method for driving a liquid crystal display panel, comprising the steps of:
providing, during a first time period after a polarity of a voltage of a driving signal of a data line is reversed, a first scanning signal to turn on a first scanning line, so as to charge a first sub pixel connected with the first scanning line through said data line;
providing, during at least one second time period after the first time period, a second scanning signal to turn on at least one second scanning line, so as to charge a second sub pixel connected with the second scanning line through said data line;
wherein a turn-on voltage of the first scanning signal is higher than a turn-on voltage of the second scanning signal, so as to compensate a difference between a charge rate of the first sub pixel charged by the data line and that of the second sub pixel charged by the data line; and
wherein a chamfering voltage of the first scanning signal is the same as a chamfering voltage of the second scanning signal, so that a sustaining voltage of the first sub pixel is the same as a sustaining voltage of the second sub pixel.

2. The method according to claim 1, wherein said data line is used for driving said first sub pixel and said at least one second sub pixel, and the polarity of the voltage of the driving signal of said data line is reversed periodically.

3. The method according to claim 2, wherein one second scanning line is provided, and a reversing cycle of the polarity of the voltage of the driving signal of said data line is equal to two scanning cycles.

4. The method according to claim 2, wherein two second scanning lines are provided, and a reversing cycle of the polarity of the voltage of the driving signal of said data line is equal to three scanning cycles.

5. The method according to claim 3, wherein the chamfering voltage of the second scanning signal is equal to the turn-on voltage thereof.

6. The method according to claim 4, wherein the chamfering voltage of the second scanning signal is equal to the turn-on voltage thereof.

7. The method according to claim 5, wherein the first time period after the polarity of the voltage of the driving signal of said data line is reversed is equal to the second time period in duration, and a turn-on time of said first scanning line is equal to a turn-on time of said at least one second scanning line in duration.

8. The method according to claim 6, wherein the first time period after the polarity of the voltage of the driving signal of said data line is reversed is equal to the second time period in duration, and a turn-on time of said first scanning line is equal to a turn-on time of said at least one second scanning line in duration.

9. The method according to claim 7, wherein the polarity of the voltage of the driving signal of said data line in the first time period is the same as that in the second time period.

10. The method according to claim 8, wherein the polarity of the voltage of the driving signal of said data line in the first time period is the same as that in the second time period.

11. The method according to claim 9, wherein a polarity reversing mode of the voltage of the driving signal of said data line is row reversion.

12. The method according to claim 10, wherein a polarity reversing mode of the voltage of the driving signal of said data line is row reversion.

13. The method according to claim 9, wherein a feedthrough voltage of said first sub pixel is the same as a feedthrough voltage of said at least one second sub pixel.

14. The method according to claim 10, wherein a feedthrough voltage of said first sub pixel is the same as a feedthrough voltage of said at least one second sub pixel.

15. The method according to claim 9, wherein a pixel array of said liquid crystal display panel is a half source driving pixel array or a tri-gate pixel array.

16. The method according to claim 10, wherein a pixel array of said liquid crystal display panel is a half source driving pixel array or a tri-gate pixel array.
